(19) United States
(12) Patent Application Publication
(10) Pub. No.: US 2006/0262331 A1
(43) Pub. Date: Nov. 23, 2006

(54) Image forming apparatus and image forming method

(75) Inventor: Yoshito Ikeda, Kanagawa (JP)

Correspondence Address: HARNESS, DICKEY & PIERCE, P.L.C., P.O. BOX 8910, RESTON, VA, 20195, US

(73) Assignee: Ricoh Company Limited

(21) Appl. No.: 11/436,568

(22) Filed: May 19, 2006

(30) Foreign Application Priority Data
May 19, 2005 (JP) 2005-146385

(51) Int. Cl. G06K 15/12

(52) U.S. Cl. 358/1.7

(57) ABSTRACT

An image forming apparatus includes a writing control unit that generates a writing clock based on a plurality of pixel clocks by adjusting a width of the writing clock in units of a width of a cycle of the pixel clock. The writing clock is then used to control emission of light from light-emitting elements when forming a latent image on a photosensitive member.

### CROSS-REFERENCE TO RELATED APPLICATIONS

The present document incorporates by reference the entire contents of Japanese priority document, 2005-146385 filed in Japan on May 19, 2005.

### BACKGROUND OF THE INVENTION

1. Field of the Invention

The present invention relates to technology for forming images by using a writing clock.

2. Description of the Related Art

In the conventional image forming apparatus of the electrophotographic system, laser beams from a laser light-emitting element, intensity of which is modulated according to content of image data of an image to be formed, are irradiated on a uniformly charged photosensitive member to form an electrostatic latent image corresponding to the content of the image data on the photosensitive member. Subsequently, toner is deposited on the electrostatic latent image. Then, the electrostatic latent image is transferred onto a transfer medium such as a paper.

In this case, the laser beams irradiated on the photosensitive member driven in a sub-scanning direction by a predetermined sub-scanning mechanism are used for scanning in a main scanning direction by a polarizer like a polygon motor.

Intensity of the laser beams irradiated from the laser light-emitting element at the time of the scanning in the main scanning direction is modulated in synchronization with pixel clocks having temporally equal intervals.

On the other hand, the laser beams irradiated on the photosensitive member via the polarizer such as the polygon motor do not originally have a physical equal interval property on the photosensitive drum because of a deflection characteristic in the polarizer. In other words, pixels forming a main scanning line on the photosensitive member are not arranged at equal intervals.

One approach can be to slightly change each of generation cycles of respective pixel clocks forming a pixel clock group for one scanning line to offset the deflection characteristic in the polarizer. However, it is difficult to perform such control in pixel clocks generated at high speed. Therefore, in the conventional image forming apparatus, an easier approach of arranging an fθ lens between the polarizer and the photosensitive member is employed.

In the past the fθ lens used to be made of glass; however, recently it has become common to make it from plastic. Although plastic lens is less expensive than a glass lens, a plastic lens is more likely to be affected by heat in the image forming apparatus.

When temperature in the image forming apparatus rises, a plastic fθ lens expands so that its correction characteristics change. When the lens expands, the pixel arrangement on the photosensitive member relative to the pixel clocks having temporally equal intervals is not at equal intervals in some cases. Moreover, because fθ lenses have magnification deviation in the main scanning direction, areas arranged at equal intervals in time (time in terms of the number of pixel clocks) in the main scanning direction are generally not physically arranged at equal intervals on the photosensitive member.

As a method of eliminating such an error, for example, Japanese Patent Application Laid-Open No. H11-129526 discloses performing frequency modulation for each arbitrary area in the main scanning direction to carry out positioning in the main scanning direction. On the other hand, Japanese Patent Application Laid-Open No. 2001-051214 discloses correcting a writing clock frequency based on a result of detection of temperature of the fθ lens to adjust an overall magnification on a photosensitive drum.

As another method of eliminating the error, Japanese Patent Application Laid-Open No. 2003-034051 discloses changing a width of a writing clock (or cycle of a writing clock) in an arbitrary main scanning image position by intermittently adjusting a cycle (e.g., by one sixteenth cycle) for a part of a pixel clock group that forms one main scanning line and performing positional correction in the main scanning direction according to the changed writing clock to adjust a laser writing position to an original target position.

However, in the technology disclosed in Japanese Patent Application Laid-Open No. 2003-034051, when it is desired to move an image writing position to the rear end side in the main scanning direction, a writing clock position in an arbitrary position is widened. Due to the widening, a main scanning position after the expansion deviates by an expanded portion of the writing clock width. This operation is repeatedly applied to the writing clock in the arbitrary position by the number of times equivalent to a necessary correction amount. This makes it possible to write an image from a desired writing start position in the main scanning direction on the photosensitive member. The magnification deviation of the fθ lens is cancelled by expanding or reducing a writing clock width according to deviation for each of areas that divide the main scanning direction.

On the other hand, some image forming apparatuses write an image using a laser light-emitting element group (an LD array) in which a plurality of laser light-emitting elements like laser diodes (LDs) are arranged in an array in the sub-scanning direction. When a writing start position in the main scanning direction is controlled to form an image based on a synchronization signal detected for a specific light-emitting element among the light-emitting elements in the image forming apparatus, ideally, the respective light-emitting elements are arranged orthogonally to the main scanning direction because deviation in the main scanning direction does not occur. However, actually, the respective light-emitting elements may be arranged obliquely to the main scanning direction because of a limit of attachment accuracy or the like.

When the respective light-emitting elements are arranged obliquely to the main scanning direction, the control for writing start positions in the main scanning direction for the respective light-emitting elements is performed based on a common synchronization signal. Thus, the writing start positions in the main scanning direction for the respective light-emitting elements are arranged obliquely rather than orthogonally to the main scanning direction. As a result, a quality of an image is deteriorated.

### SUMMARY OF THE INVENTION

It is an object of the present invention to at least partially solve the problems in the conventional technology.

According to an aspect of the present invention, an image forming apparatus includes a light-emitting unit including a plurality of light-emitting elements arranged in a direction substantially orthogonal to a main scanning direction of a photosensitive member; an element control unit that controls emission of light from respective light-emitting elements of the light-emitting unit; a writing control unit that generates a writing clock based on a plurality of pixel clocks and controls the element control unit in such a manner that the light-emitting element emit light from a writing start position on the photosensitive member based on the writing clock to form a latent image on the photosensitive member; and an image forming unit that applies toner to the latent image on the photosensitive member to obtain a toner image, and transfers the toner image onto a recording medium, wherein the writing control unit adjusts a width of a cycle of the writing clock in units of a width of a cycle of a pixel clock.

According to another aspect of the present invention, an image forming method includes generating a writing clock based on a plurality of pixel clocks; controlling a plurality of light-emitting elements that emit light to perform image writing from a writing start position on a photosensitive member according to generated writing clock, the light-emitting elements being arranged in a direction substantially orthogonal to a main scanning direction of the photosensitive member thereby forming a latent image on the photosensitive member; adjusting a width of a cycle of the writing clock in units of a width of a cycle of a pixel clock during the controlling; and applying toner on the latent image thereby forming a toner image, and transferring the toner image onto a recording medium.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a digital copying machine according to an embodiment of the present invention;

FIG. 2 is a schematic of a printer unit 30 shown in FIG. 1;

FIG. 3 is a block diagram of a writing control unit shown in FIG. 1;

FIG. 4 is a block diagram of an output-data control unit 34 shown in FIG. 4;

FIG. 5 is a schematic of a temperature detecting unit shown in FIG. 1;

FIG. 6 is a schematic of a state in which respective LD elements are arranged orthogonally to a main scanning direction;

FIG. 7 is a schematic of a state in which the respective LD elements are not arranged orthogonally to the main scanning direction;

FIG. 8 is a schematic of a state of deviation of image writing positions due to arrangement deviation of the respective LD elements;

FIG. 9 is a diagram for explaining waveforms for one cycle of a writing clock of an LD element set as a reference (a reference writing clock), a writing clock expanded by one pixel (+ 1/16), and a writing clock reduced by one pixel (− 1/16);

FIG. 10A is a diagram for explaining a relation among the writing clock in the LD element set as a reference (the reference writing clock), a pixel clock forming the writing clock, and an image writing start position;

FIG. 10B is a diagram for explaining a relation among a writing clock, a pixel clock, and an image writing start position at the time when one cycle of the writing clock is expanded by one pixel (+ 1/16);

FIG. 11A is a diagram for explaining a relation among the writing clock in the LD element set as a reference (the reference writing clock), a pixel clock forming the writing clock, and an image writing start position;

FIG. 11B is a diagram for explaining a relation among a writing clock, a pixel clock, and an image writing start position at the time when one cycle of the writing clock is reduced by one pixel (− 1/16); and

FIG. 12 is a flowchart of a procedure of expansion processing for a writing clock.

### DETAILED DESCRIPTION OF THE PREFERRED EMBODIMENTS

Exemplary embodiments of the present invention are explained in detail below with reference to the accompanying drawings.

In an embodiment of the present invention, an image forming apparatus of the present invention is applied to a digital copying machine. However, the present invention is not limited to this. It is also possible to apply the image forming apparatus to a printer apparatus, a facsimile apparatus, and a multi-function product that stores a printer function, a facsimile function, and a copying function in one housing.

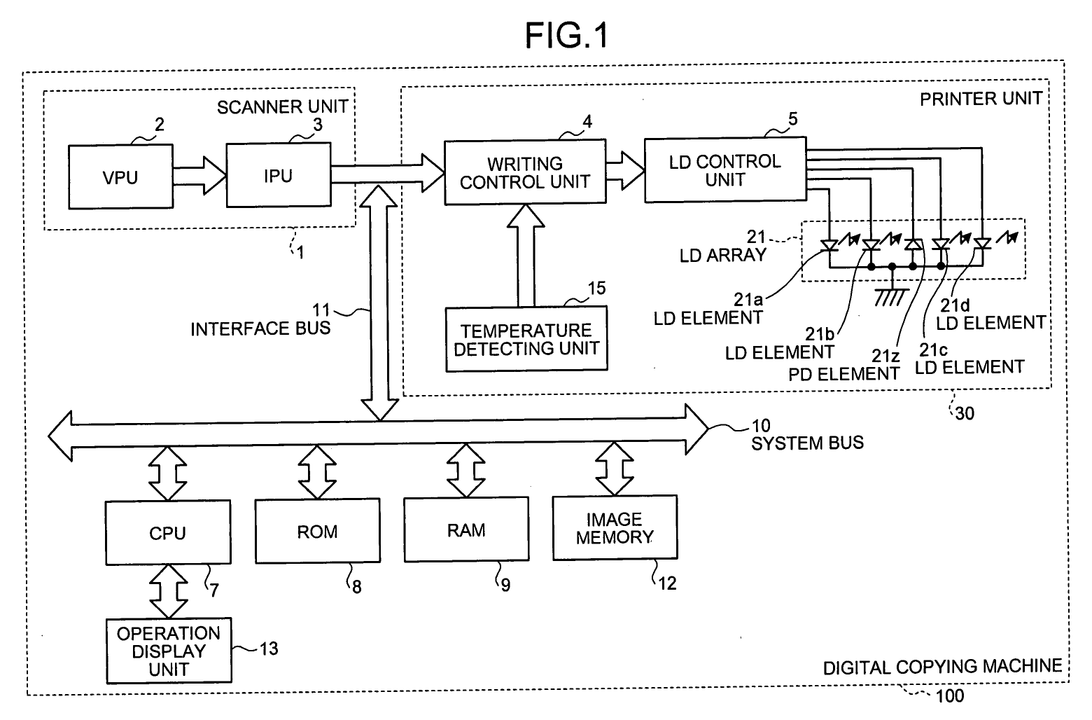

FIG. 1 is a block diagram of a digital copying machine 100 according to an embodiment of the present invention. The digital copying machine 100 includes a scanner unit 1, a printer unit 30, a central processing unit (CPU) 7, a read only memory (ROM) 8, a random access memory (RAM) 9, an image memory 12, and an operation display unit 13.

The scanner unit 1 reads an image of an original (original image). The scanner unit 1 includes a visual processing unit (VPU) 2 and an image processing unit (IPU) 3. The VPU 2 subjects a signal corresponding to the original image to A/D conversion to perform black offset correction, shading correction, and pixel position correction and the IPU 3 performs image processing for image data subjected to the various kinds of correction by the VPU 2.

The printer unit 30 irradiates laser beams from a laser light-emitting element (not shown), intensity of which is modulated according to content of the image data, on a uniformly charged photosensitive drum (not shown) to form an electrostatic latent image corresponding to the content of the image data on the photosensitive drum. The printer unit 30 then deposits toner on the electrostatic latent image and transfers the electrostatic latent image onto a transfer medium, such as recording paper, to form an image on the recording paper. The printer unit 30 can be an application specific integrated circuit (ASIC) or the like. The printer unit 30 includes a writing control unit 4 that performs overall control for the printer unit 30, a laser diode (LD) array 21 serving as a light-emitting element group, an LD control unit 5 that performs light emission control for the LD array 21, and a temperature detecting unit 15 that detects temperature in the printer unit 30. The LD array 21 includes four LD elements 21a to 21d serving as laser light-emitting elements for four channels and a photo-diode (PD) element 21z serving as a photo-detection element for adjusting light-emitting intensity of the respective LD elements. It is sufficient that the temperature detecting unit 15 measures the temperature of the printer unit 30, and whether it is arranged inside or outside of the printer unit 30 is not important.

The LD array 21 forms an image of electrostatic latent image data on the photosensitive drum. The LD elements 21a to 21d are linearly arranged in a direction orthogonal to a main scanning direction that is a rotation axis direction (a width direction) of the photosensitive drum (i.e., a direction parallel to a sub-scanning direction). However, since there is a limit in attachment accuracy of the LD array 21, it is difficult to arrange the LD elements 21a to 21d in a direction perfectly orthogonal to the main scanning direction.

The CPU 7 is a central processor that executes control for the entire apparatus. The ROM 8 is a storage medium that stores a control program executed by the CPU 7. The RAM 9 is a storage medium used as a work area by the control program.

The image memory 12 stores therein read image. A system bus 10 is a data line through which the CPU 7, the ROM 8, the RAM 9, and the image memory 12 exchange data.

The system bus 10 and the IPU 3 are connected via an interface bus 11. The CPU 7 and the like on the system bus 10 can exchange data with the IPU 3. The operation display unit 13 is connected to the CPU 7. The operation display unit 13 displays various screens for a user and receives operation inputs from the user. The operation display unit 13 is a display unit, such as a liquid crystal display unit, that displays the various screens and on which touch inputs from the various screens are possible and an operation unit (not shown) including operation buttons and the like.

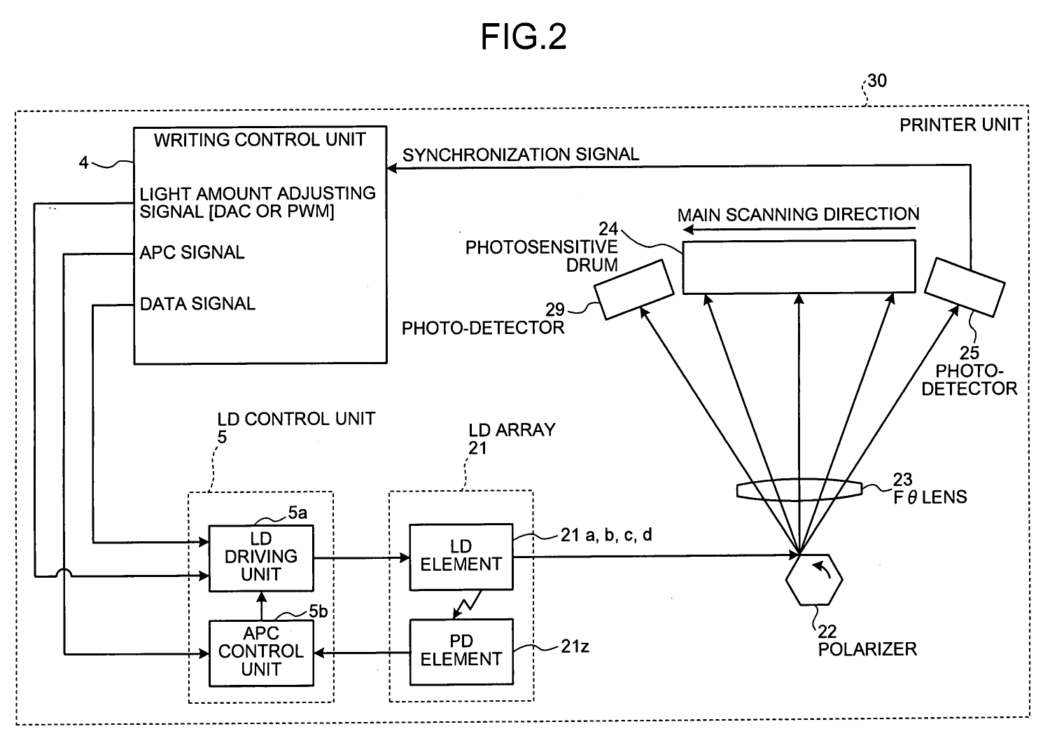

FIG. 2 is a schematic of a detailed constitution of the printer unit 30. The respective LD elements 21a to 21d constituting the LD array 21 are arranged in parallel to a rotation axis of a polarizer 22 that extends in a direction orthogonal to the main scanning direction that is a rotation axis direction (a width direction) of a photosensitive drum 24. Laser beams emitted forward from the respective LD elements 21a to 21d are changed to parallel light beams by a collimator lens (not shown) and deflected by the polarizer 22, which can be a rotary polygon mirror. The deflected laser beams are focused on the surface of the photosensitive drum 24, which is uniformly charged by a charging device (not shown), by an fθ lens 23. Focusing spots of the laser beams repeatedly move in the rotation axis direction of the photosensitive drum 24 (the main scanning direction) according to the rotation of the polarizer 22. On the other hand, when the photosensitive drum 24 is driven to rotate, the laser beams are irradiated in the sub-scanning direction of the photosensitive drum 24.

A photo-detector 25 is a photo-detection device provided outside an information writing area corresponding to the width of the photosensitive drum 24. The photo-detector 25 detects the laser beams deflected by the polarizer 22 to generate a synchronization detection signal. The synchronization detection signal emitted from the photo-detector 25 is inputted to the writing control unit 4.

The writing control unit 4 inputs a DATA signal based on image data of an image to be formed, which is obtained by reading an original with the scanner unit 1, to an LD driving unit 5a in the LD control unit 5 as a drive control signal. The LD driving unit 5a inputted with the DATA signal drives the respective LD elements 21a to 21d based on the DATA signal.

The writing control unit 4 controls timing of the DATA signal inputted to the LD driving unit 5a according to a synchronization signal outputted from the photo-detector 25. The driving timing for four (four channels of) LD elements, the LD elements 21a to 21d, is controlled according to a single synchronization signal, that is, a single synchronization signal obtained by detecting a laser beam emitted from a specific LD element in the LD elements 21a to 21d, for example, the LD element 21a with the photo-detector 25.

The LD driving unit 5a drives the LD elements 21a to 21d according to the DATA signal from the writing control unit 4 to form an electrostatic latent image on the photosensitive drum 24. The electrostatic latent image is developed by a developing device (not shown) and transferred onto transfer paper or the like by a transfer device (not shown).

Laser beams emitted backward from the respective LD elements 21a to 21d in the LD array 21 are made incident on the PD element 21z and light intensity of the laser beams is detected. A light reception signal based on the light intensity is supplied to an Auto Power Control (APC) control unit 5b of the LC control unit 5.

The APC control unit 5b performs APC control. The APC control unit 5b controls the LD driving unit 5a according to the light reception signal outputted from the PD element 21z and controls output light amounts of the LD elements 21a to 21d of the LD array 21 to be fixed with respect to the DATA signal at a specific level from the writing control unit 4.

Specifically, the APC control unit 5b adjusts driving power supplies for the LD elements 21a to 21d of the LD array 21 to fix output light amounts of respective light-emitting elements according to a light reception signal detected when laser beams from the respective LD elements are received by the PD element 21z. The APC control unit 5b holds adjusted amounts of the output light amounts and controls laser beam intensity of the respective LD elements 21a to 21d not to fluctuate during an image formation operation.

A photo-detector 29 is arranged on the rear side in the main scanning direction outside an effective image area of the photosensitive drum 24 and used together with the photo-detector 25 on the front side in pairs. The photo-detector 29 calculates an error of the entire fθ lens 23 using a time difference in scanning the respective detectors with laser beams. The temperature detecting unit 15 has not been shown in FIG. 2 for simplicity.

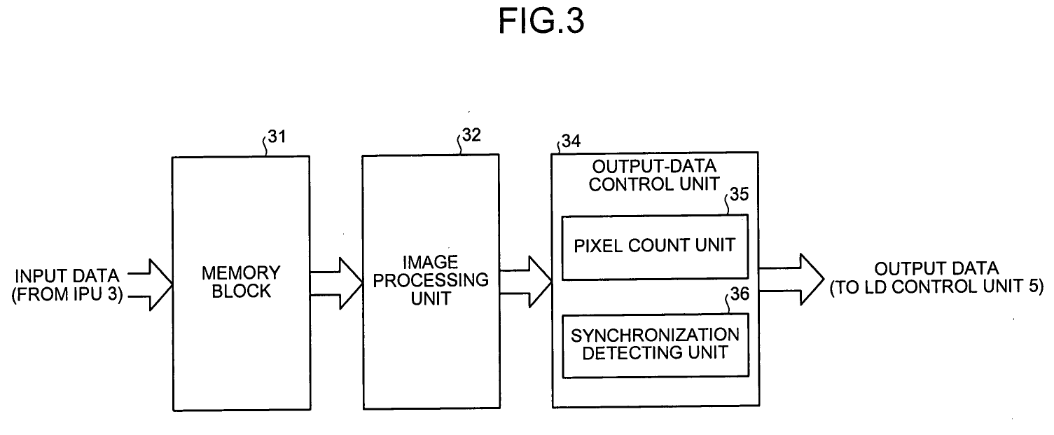

FIG. 3 is a detailed block diagram of the writing control unit 4. The writing control unit 4 includes a memory block 31, an image processing unit 32, and an output-data control unit 34.

The memory block 31 performs speed conversion and format conversion of image data received from the IPU 3 of the scanner unit 1. The image processing unit 32 applies image processing to image data outputted from the memory block 31. The output-data control unit 34 applies processing like γ conversion and P sensor pattern imparting to the image data outputted from the image processing unit 32 and outputs the image data subjected to such processing to the LD control unit 5 as output data. The output-data control unit 34 includes a pixel count unit 35 that counts the number of pixels in the main scanning direction and a synchronization detecting unit 36 that detects a synchronization signal using the photo-detector 25.

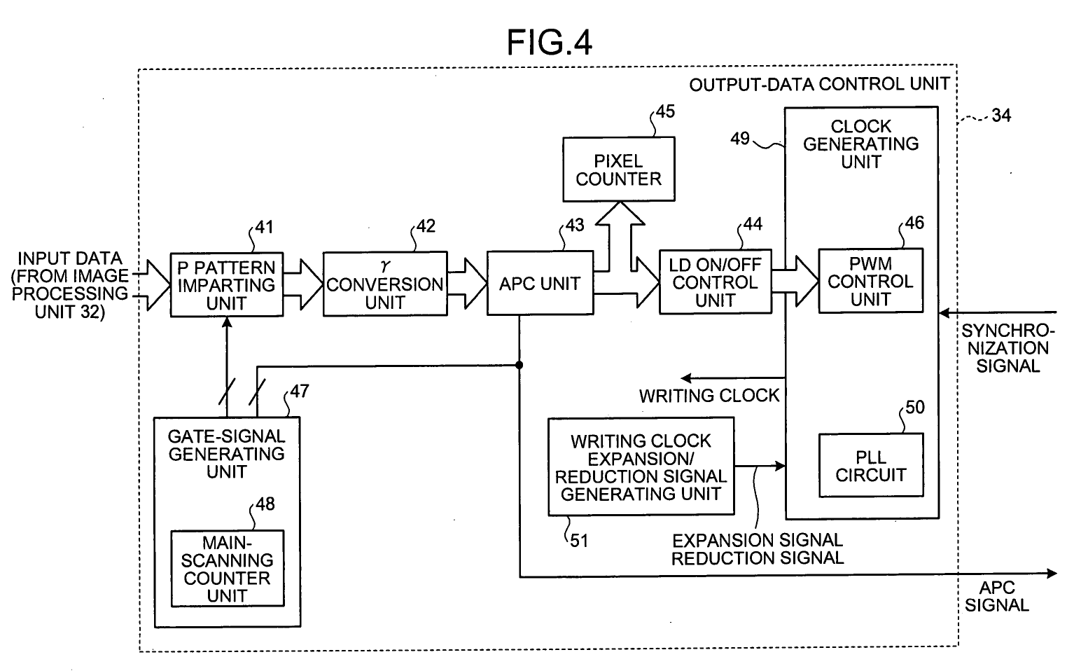

FIG. 4 is a detailed block diagram of the output-data control unit 34. The output-data control unit 34 includes a P pattern imparting unit 41, a γ conversion unit 42, an APC unit 43, an LD ON/OFF control unit 44, a pixel counter 45, a clock generating unit 49, a gate-signal generating unit 47, and a writing clock expansion/reduction signal generating unit 51.

The P pattern imparting unit 41 imparts a P sensor pattern for placing a toner with certain fixed concentration on the photosensitive drum 24 for data acquisition for determining process conditions to the image data inputted from the image processing unit 32. The γ conversion unit 42 performs processing for changing a data weight of the image data after P sensor pattern imparting processing by the P pattern imparting unit 41.

The APC unit 43 imparts an image in synchronization with APC operation timing for keeping an amount of light of the LD elements 21a to 21d. The pixel counter 45 measures the number of light-emitting dots of the respective LD elements 21a to 21d.

The LD ON/OFF control unit 44 imparts light emission data for synchronization detection to data outputted from the APC unit 43.

The gate-signal generating unit 47 includes a main scanning counter unit 48. The gate-signal generating unit 47 generates a gate signal required for the respective kinds of processing with reference to the main scanning counter unit 48 and outputs the gate signal to the P pattern imparting unit 41 and the APC unit 43.

The clock generating unit 49 is constituted by a pixel clock group on one main scanning line. The clock generating unit 49 generates a writing clock for setting writing timing for writing by the LD elements 21a to 21d in a writing start position on the photosensitive drum 24. The clock generating unit 49 mainly includes a Pulse Width Modulation (PWM) control unit 46 and a Phase-Locked Loop (PLL) circuit 50. The PWM control unit 46 applies PWM control to image data outputted from the LD ON/OFF control unit 44. The PWM control unit 46 applies PWM control to image data outputted from the LD ON/OFF control unit 44. The PLL circuit 50 is a circuit that precisely adjusts an oscillation frequency. A synchronization signal as well as a clock expansion signal and a clock reduction signal described later are inputted to the clock generating unit 49 as input signals. The clock generating unit 49 outputs a writing clock as an output signal.

The writing clock expansion/reduction signal generating unit 51 generates, in respective cycles of a writing clock, an expansion signal for instructing expansion of the writing clock in units of a width of one cycle of pixel clocks forming the writing clock and a reduction signal for instructing reduction of the writing clock in units of a width of one cycle of the pixel clock. The writing clock expansion/reduction signal generating unit 51 outputs the expansion signal and the reduction signal to the clock generating unit 49.

When the clock expansion signal is inputted, the clock generating unit 49 expands a width of the writing lock in units of a width of the pixel clock. When the clock reduction signal is inputted, the clock generating unit 49 reduces a width of the writing clock in units of a width of the pixel clock. Specifically, when the clock expansion signal or the clock reduction signal is inputted, the clock generating unit 49 performs an expansion operation or a reduction operation for the writing clock in an arbitrary position (at arbitrary timing) in a period from detection of a synchronization signal to start of image writing (a leading end of an image) with reference to a count value of the main scanning counter unit 48 using the gate-signal generating unit 47.

As the reduction operation for the writing clock, outside the effective image area of the photosensitive drum 24, the clock generating unit 49 expands or reduces the writing clock by a width in pixel clock units set in advance at the time of shipment from a factory. On the other hand, within the effective image area of the photosensitive drum 24, the clock generating unit 49 expands or reduces the writing clock by a width in pixel clock units based on temperature in the apparatus detected by the temperature detecting unit 15.

Specifically, when the temperature in the apparatus detected is within a first temperature range, the clock generating unit 49 determines an expansion width in pixel clock units according to the temperature detected and expands one cycle of the writing clock by the expansion width determined.

On the other hand, when the temperature in the apparatus detected is within a second temperature range, the clock generating unit 49 determines a reduction width in pixel clock units according to the temperature detected and reduces one cycle of the writing clock by the reduction width determined.

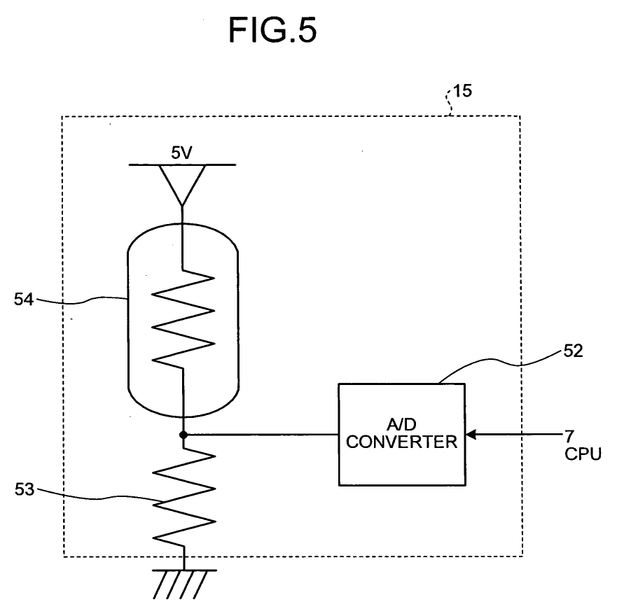

FIG. 5 is a schematic of the temperature detecting unit 15. The temperature detecting unit 15 includes a thermistor 54, a non-variable resistor 53, and an A/D converter 53. The temperature detecting unit 15 subjects a voltage obtained by resistance division of the thermistor 54 and the non-variable resistor 53 to A/D conversion using the A/D converter 52, monitors the voltage using the CPU 7, and calculates temperature in the apparatus. Information on the calculated temperature is outputted to the writing clock expansion/reduction signal generating unit 51 and the clock generating unit 49.

Expansion processing for a writing clock in the digital copying machine 100 is explained below. In expansion of a writing clock, a direction of the expansion and the number of expansions are set.

Specifically, when a clock expansion signal and a clock reduction signal are generated by the writing clock expansion/reduction signal generating unit 51, control of ± 1/16 clock is applied to a reference writing clock. For example, when the setting is performed sixteen times in a plus direction, a main scanning writing start position of an image is farther apart from a synchronization detection position by one pixel (((+ 1/16) clock)×16 times=1 pixel). When the setting is performed sixteen times in a minus direction, the main scanning writing start position of the image is closer from the synchronization detection position by one pixel (((− 1/16) clock)×16 times=1 pixel).

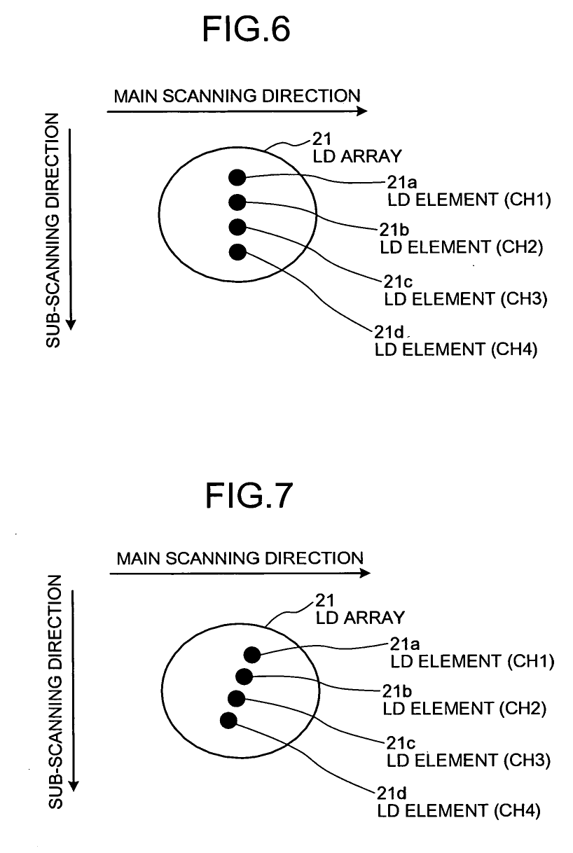

FIG. 6 is a schematic of a state in which the respective LD elements 21a to 21d of the LD array 21 are arranged orthogonally to the main scanning direction. When the respective LD elements 21a to 21d are arranged accurately orthogonally to the main scanning direction as shown in the figure, a synchronization signal is detected for one LD element 21a among the LD elements 21a to 21d of ch1 to ch4. Writing start positions (distances in terms of the number of writing clocks from synchronization signal detection timing) are set identical with that of the LD element 21a based on the synchronization signal. Consequently, it is possible to set writing start positions for the respective LD elements of the respective channels orthogonal to the main scanning direction (parallel to the sub-scanning direction). Thus, it is possible to perform satisfactory image formation.

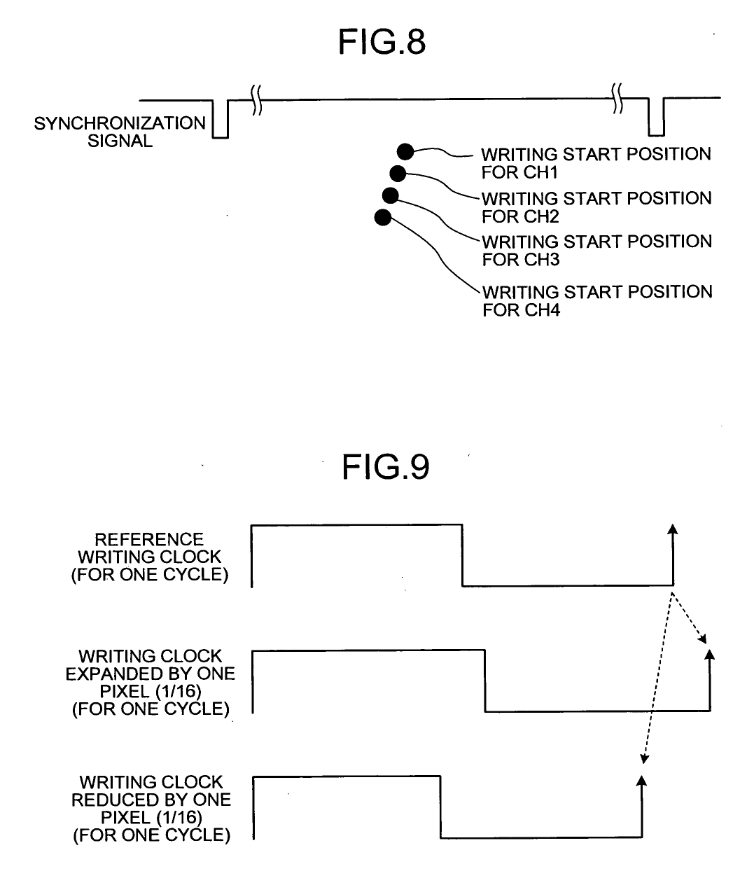

However, there is a limit to how accurately the LD array 21 can be positioned. In reality, in most cases, as shown in FIG. 7, the respective LD elements 21a to 21d are not arranged exactly orthogonally to the main scanning direction. In such an arrangement, the respective LD elements 21a to 21d of ch1 to ch4 start writing at identical timing. In other words the respective LD elements 21a to 21d start writing at timing after time elapses by the identical number of writing clocks in terms of the number of writing clocks from the synchronization signal detection. Then, as shown in FIG. 8, writing start positions on the photosensitive drum 24 directly reflect arrangement deviation of the respective LD elements 21a to 21d. As a result, the writing start positions are not arranged orthogonally to the main scanning direction to cause deterioration in an image quality of an image to be formed.

To solve the problem, in the digital copying machine 100, based on the LD element 21a of ch1 among the LD elements 21a (ch1) to 21d (ch2), an arrangement deviation amount between the main scanning direction and the direction orthogonal to the main scanning direction of the other LD elements 21b to 21d is corrected by expanding or reducing one or a plurality of clocks among writing clocks in respective cycles from synchronization signal detection to writing start in units of a width of one cycle of a pixel clock.

Specifically, to adjust a writing start position of the LD element 21b of ch2 to a writing start position of the LD element 21a of ch1, it is necessary to delay a writing start position (timing) of ch2. For that purpose, the clock expansion of (+ 1/16) is applied only to a plurality of pixels (in this case, sixteen pixels). The number of the pixels is equivalent to deviation in the main scanning direction (in this case, assumed to be one clock cycle) of the LD element 21a of ch1 and the LD element 21b of ch2 in the writing clocks in the respective cycles from synchronization signal detection to writing start among the writing clocks for the LD element 21b of ch2.

FIG. 9 is a diagram for explaining waveforms for one cycle of a writing clock of a LD element set as a reference (a reference writing clock), a writing clock expanded by one pixel (+ 1/16), and a writing clock reduced by one pixel (− 1/16).

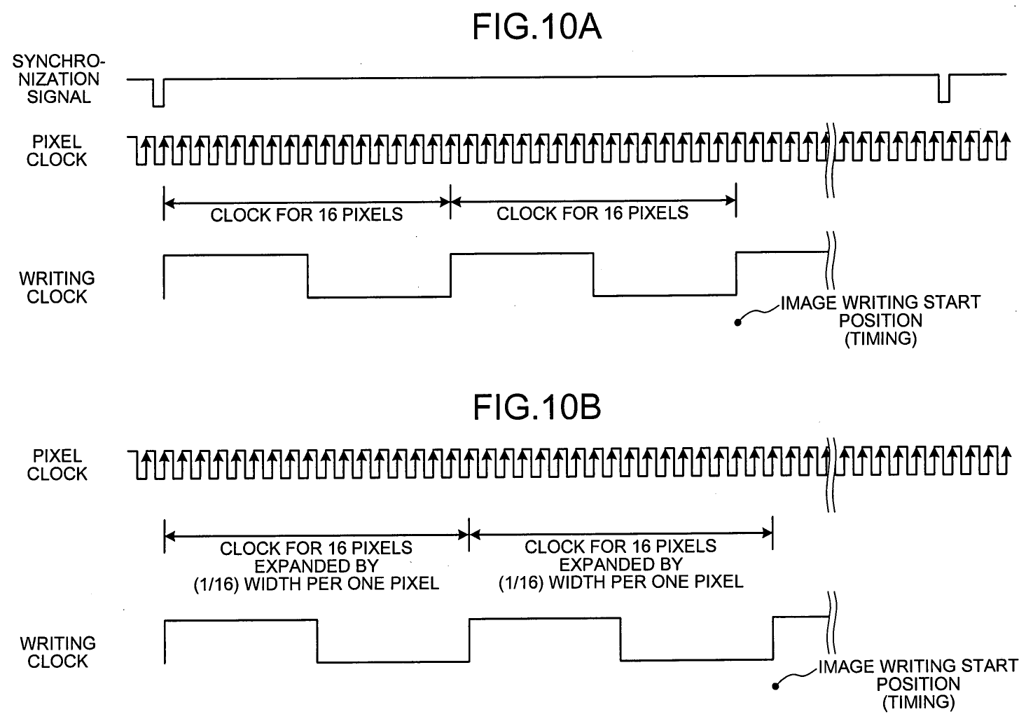

FIG. 10A is a diagram for explaining a relation among the writing clock in the LD element set as a reference (the reference writing clock), a pixel clock forming the writing clock, and an image writing start position. FIG. 10B is a diagram for explaining a relation among a writing clock, a pixel clock, and an image writing start position at the time when one cycle of the writing clock is expanded by one pixel (+ 1/16).

As shown in FIG. 9 and FIGS. 10A and 10B, timing of writing start is delayed in association with arrangement deviation of LD elements by expanding one cycle of a writing clock of an LD element (e.g., the LD element 21b) other than the LD element set as a reference with respect to the writing clock of the LD element set as a reference (e.g., the LD element 21a). An image writing start position is set orthogonally to the main scanning direction by applying expansion in pixel clock units of the writing clock to the other LD elements according to a state of arrangement deviation of the LD elements in this way. As a result, it is possible to improve an image quality.

In FIG. 10B, a clock width is expanded with respect to each of two cycles of the writing clock. However, the present invention is not limited to this. The clock width may be expanded with respect to only one cycle of the writing clock.

In the example explained above, the LD element 21a is set as a reference. However, for example, when the LD element 21b is set as a reference, an operation for reducing a writing clock of the LD element 21a only has to be performed.

A third waveform from the top in FIG. 9 is a waveform for one cycle of a writing clock obtained by reducing the writing clock of the LD element set as a reference by one pixel (− 1/16).

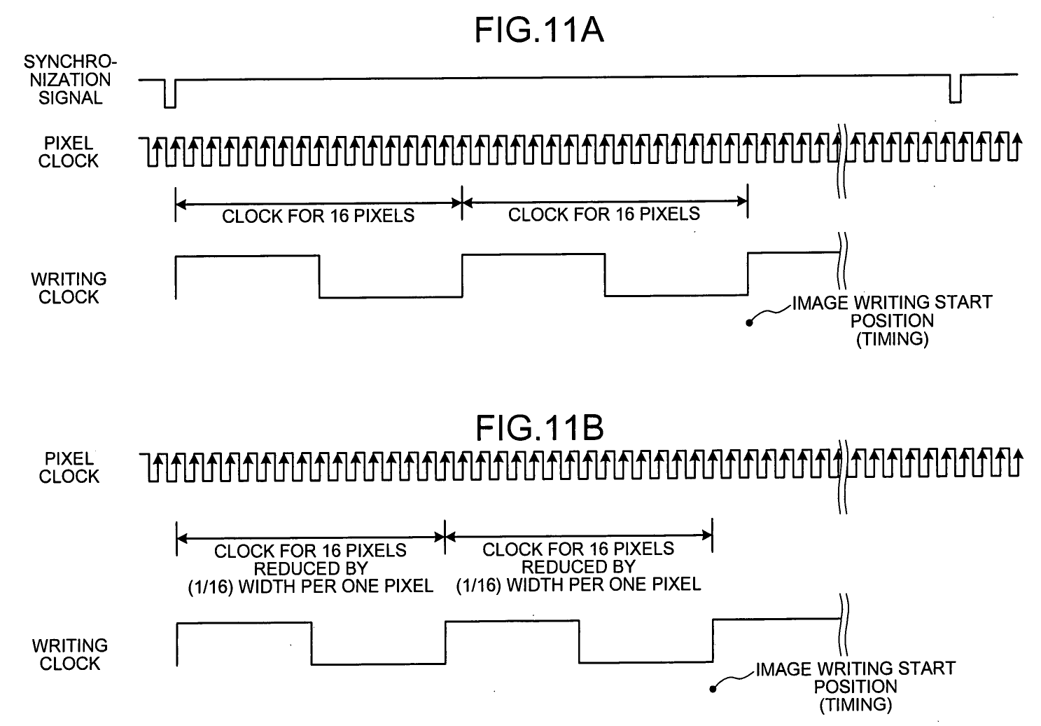

FIG. 11A is a diagram for explaining a relation among the writing clock in the LD element set as a reference (the reference writing clock), a pixel clock forming the writing clock, and an image writing start position. FIG. 11B is a diagram for explaining a relation among a writing clock, a pixel clock, and an image writing start position at the time when one cycle of the writing clock is reduced by one pixel (− 1/16).

As shown in FIG. 9 and FIGS. 11A and 11B, since the LD element 21a of ch1 deviates in a forward direction with respect to the LD element 21b of ch2 set as a reference, clock reduction of (− 1/16) only has to be applied to sixteen pixels. An image writing start position is set orthogonally to the main scanning direction by performing reduction in pixel clock units of the writing clock in this way. As a result, it is possible to improve an image quality. In FIG. 11B, a clock width is reduced with respect to each of two cycles of the writing clock. However, the present invention is not limited to this. The clock width may be reduced with respect to only one cycle of the writing clock.

Since it is possible to perform expansion and reduction of the writing clock at accuracy in units of a pixel clock, that is, units of one pixel that is a ( 1/16) cycle of a cycle of the writing clock, it is possible to accurately correct deviation in the main scanning direction of the LD elements of the respective channels.

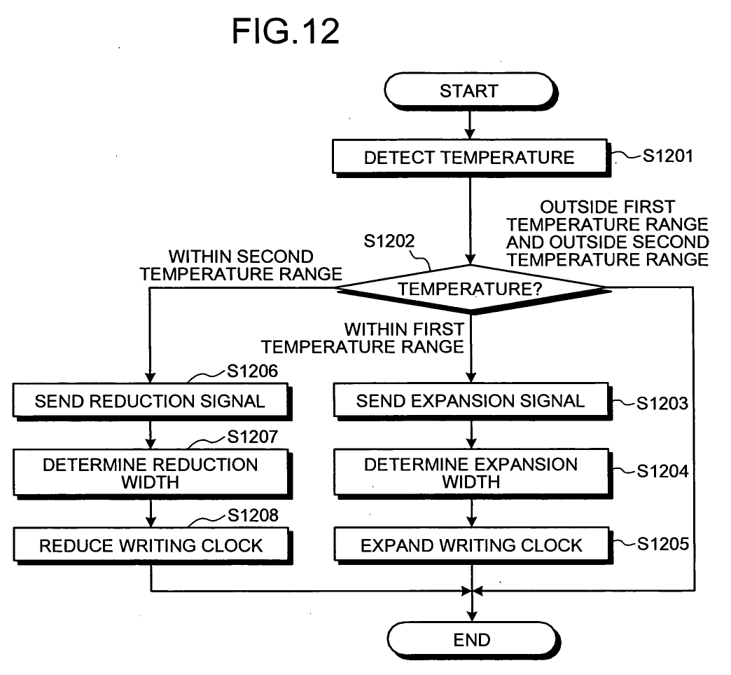

A procedure of expansion/reduction processing for a writing clock is explained. FIG. 12 is a flowchart of the procedure of the expansion/reduction processing for a writing clock. In FIG. 12, expansion/reduction processing in an image effective area of the photosensitive drum 24 is explained.

First, the temperature detecting unit 15 detects temperature in the apparatus (step S1201). The temperature detecting unit 15 judges whether the temperature is within a first temperature range and a second temperature range set in advance (step S1202).

When the temperature detected is within the first temperature range, the writing clock expansion/reduction signal generating unit 51 generates a clock expansion signal and sends the clock expansion signal to the clock generating unit 49 (step S1203). The clock generating unit 49 receives the clock expansion signal and determines an expansion width in units of a pixel clock (one pixel) based on the temperature detected (step S1204). The clock generating unit 49 expands the writing clock by the expansion width determined (step S1205).

On the other hand, when the temperature detected is within the second temperature range, the writing clock expansion/reduction signal generating unit 51 generates a clock reduction signal and sends the clock reduction signal to the clock generating unit 49 (sep S1206). The clock generating unit 49 receives the clock reduction signal and determines a reduction width in units of a pixel clock (one pixel) based on the temperature detected (step S1207). The clock generating unit 49 reduces the writing clock by the reduction width determined (step S1208). When the temperature detected is not included both the first temperature range and the second temperature range at step S1202, the expansion processing for the writing clock is not performed.

As described above, in the digital copying machine 100 according to this embodiment, predetermined writing start positions for the respective LD elements 21a to 21d are arranged without deviation in the main scanning direction regardless of arrangement deviation amounts in the main scanning direction of the respective LD elements 21a to 21d. This makes it possible to perform satisfactory image formation even when accuracy in attaching the LD array 21 is low.

In the digital copying machine 100 according to this embodiment, expansion and reduction of a writing clock are performed in units of a pixel clock, that is, in units of one pixel. This makes it possible to highly accurately correct deviation in the main scanning direction of the respective LD elements.

Moreover, in the digital copying machine 100 according to this embodiment, expansion and reduction of a writing clock are performed based on temperature in the apparatus. Thus, even when a change in a correction characteristic due to deformation or the like of an fθ lens made of plastic is caused by a temperature change in the apparatus, predetermined writing start positions for the respective LD elements 21a to 21d are arranged without deviation in the main scanning direction. This makes it possible to always perform satisfactory image formation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a light-emitting unit including a plurality of light-emitting elements arranged in a direction substantially orthogonal to a main scanning direction of a photosensitive member;
an element control unit that controls emission of light from respective light-emitting elements of the light-emitting unit;
a writing control unit that generates a writing clock based on a plurality of pixel clocks and controls the element control unit in such a manner that the light-emitting element emit light from a writing start position on the photosensitive member based on the writing clock to form a latent image on the photosensitive member; and
an image forming unit that applies toner to the latent image on the photosensitive member to obtain a toner image, and transfers the toner image onto a recording medium,
wherein the writing control unit adjusts a width of a cycle of the writing clock in units of a width of a cycle of a pixel clock.

2. The image forming apparatus according to claim 1, wherein the writing control unit adjusts, outside an effective image area of the photosensitive member, a width of a cycle of the writing clock in units of a predetermined width of a cycle of the pixel clock.

3. The image forming apparatus according to claim 2, further comprising a temperature detecting unit that detects temperature in the image forming apparatus, wherein
the writing control unit adjusts, in the effective image area of the photosensitive member, a width of a cycle of the writing clock in units of a width of a cycle of the pixel clock based on the temperature detected by the temperature detecting unit.

4. The image forming apparatus according to claim 3, wherein, when the temperature detected by the temperature detecting unit is within a first temperature range, the writing control unit expands, in the effective image area of the photosensitive member, the width of a cycle of the writing clock.

5. The image forming apparatus according to claim 4, wherein, when the temperature detected by the temperature detecting unit is within a second temperature range, the writing control unit reduces, in the effective image area of the photosensitive member, a width of a cycle of the writing clock.

6. The image forming apparatus according to claim 1, wherein the writing control unit adjusts a width of a plural cycles of the writing clocks in units of a width of a cycle of the pixel clock.

7. The image forming apparatus according to claim 1, further comprising a light detecting unit that is arranged in a predetermined position in the main scanning direction and detects light emitted from a predetermined light-emitting element among the light-emitting elements.

8. The image forming apparatus according to claim 7, wherein the writing control unit controls the element control unit to emit irradiation light from a writing start position on the photosensitive member based on the writing clock that starts from a time point when the light detecting unit detects the light.

9. An image forming method comprising:
generating a writing clock based on a plurality of pixel clocks;
controlling a plurality of light-emitting elements that emit light to perform image writing from a writing start position on a photosensitive member according to generated writing clock, the light-emitting elements being arranged in a direction substantially orthogonal to a main scanning direction of the photosensitive member thereby forming a latent image on the photosensitive member;
adjusting a width of a cycle of the writing clock in units of a width of a cycle of a pixel clock during the controlling; and
applying toner on the latent image thereby forming a toner image, and transferring the toner image onto a recording medium.
